(19) United States
(12) Patent Application Publication
(10) Pub. No.: US 2010/0025950 A1
(43) Pub. Date: Feb. 4, 2010

(54) BALL JOINT, PREFERABLY FOR USE IN VEHICLES

(76) Inventors: Frank Budde, Damme (DE); Markus Thoelking, Dinklage (DE); Olaf Abels, Damme (DE); Werner Duesing, Loeningen (DE)

Correspondence Address: MCGLEW & TUTTLE, PC, P.O. BOX 9227, SCARBOROUGH STATION, SCARBOROUGH, NY, 10510-9227, US

(21) Appl. No.: 11/722,394

(22) PCT Filed: Dec. 21, 2005
(86) PCT No.: PCT/DE05/02309

§ 371 Date: Oct. 1, 2008

(30) Foreign Application Priority Data
Dec. 22, 2004 (DE) 10 2004 063 013.5

(51) Int. Cl. B62D 7/16; F16C 11/06

(52) U.S. Cl. 280/93.511; 403/134

(57) ABSTRACT

A ball and socket joint is provided preferably for use in vehicles and especially in the area of the chassis of motor vehicles. The joint has a ball and socket joint housing having a joint opening, with a ball pivot, which is arranged in the ball and socket joint housing, extends through the joint opening and has a shaft. A support ring is arranged on the shaft of the ball pivot and has a radially extending flange. A sealing element is arranged between the support ring as well as an adjoining component formed by a profiled body (15), which is connected to the support ring (5) in substance, is provided with at least one sealing segment (16) and is in contact with the shaft (10) of the ball pivot (1) and/or with a connection component (11) in at least one profiled section via a sealing segment (16). The profiled body is arranged at the flange (13) of the support ring (5) and/or in the flange transition area (14), which establishes the connection between the flange (13) and an axial extension area (12) of the support ring (5).

### CROSS REFERENCE TO RELATED APPLICATIONS

This application is a United States National Phase application of International Application PCT/DE2005/002309 and claims the benefit of priority under 35 U.S.C. §119 of German Patent Application DE 10 2004 063 013.5 filed Dec. 22, 2004, the entire contents of which are incorporated herein by reference.

### FIELD OF THE INVENTION

The present invention pertains to a ball and socket joint, preferably for use in vehicles, especially in the area of the chassis of motor vehicles, with a ball and socket joint housing having a joint opening, with a ball pivot, which is arranged in the ball and socket joint housing, extends through the joint opening and has a shaft, with a support ring, which is arranged on the shaft of the ball pivot and has a radially extending flange, and with a sealing element, which is arranged between the support ring as well as an adjoining component.

### BACKGROUND OF THE INVENTION

It is usually necessary in ball and socket joints to guarantee the relative motion of the joint parts in relation to one another without impairment of the function at least over a predetermined duration of use for the given type of ball and socket joint. There must be sufficient sealing against external effects, especially against the penetration of foreign bodies and moisture. Support rings, which are arranged on the ball pivot of the ball and socket joint, and on which the pivot-side sealing labyrinth of a sealing bellows can be sealingly fixed, are used for this purpose.

A ball and socket joint for motor vehicles, which has a gasket made of an elastically deformable material between the housing of the ball and socket joint and a ball pivot carrying the joint ball, is known in this connection from DE-OS 37 05 847. A support ring, which is adheringly arranged on the ball pivot and meshes with the bearing surface of the gasket in a positive-locking manner, is inserted between the bearing surface of the gasket and the ball pivot.

The sealing in the area of the support ring is ensured in this solution by the support ring being provided with a coating consisting of an elastic material.

Furthermore, a ball and socket joint, which comprises essentially a ball pivot and a ball socket for holding the head of the ball pivot with a bearing inserted between them, is known from DE 103 00 678 A1. Furthermore, the ball and socket joint has a holding ring, which comprises a cylindrical part, which is arranged at an outer circumferential surface of the shaft of the ball pivot, and a flange, which projects from one end of the cylindrical part of the holding ring and comes into close contact with a mounting bead of a cuff.

Within the framework of this teaching, the area in which the holding ring is arranged at the shaft of the ball pivot is filled with a sealant, which penetrates as a liquid into recesses in this area.

### SUMMARY OF THE INVENTION

The basic object of the present invention is to improve a ball and socket joint such that its ability to function is preserved over comparatively long periods of time independently from the concrete design of the joint, without being adversely affected by corrosion phenomena in the area of the ball pivot.

The object is accomplished according to the present invention on a ball and socket joint of the type described by arranging a profiled body, which is connected to the support ring in substance, is provided with at least one sealing segment and is in contact with the shaft of the ball pivot and/or with a connection component via a sealing segment in at least one profiled section, at the flange of the support ring and/or in the flange transition area, which establishes the connection between the flange and an axial area of extension of the support ring.

The present invention is associated with the advantage that reliable sealing action is achieved based on the preset positioning of the flange or the flange transition area and the sealing segment relative to one another and the properties of the at least one sealing segment, which are coordinated with the particular use.

To embody a strong sealing action, which is selectively necessary in the area close to the ball pivot, the connection in substance between the flange transition area and the profiled body is present in the embodiment of the present invention. The profiled body is in contact with the shaft of the ball pivot and/or with the connection component in one or more of its profiled sections via at least one sealing segment.

In embodying defined sealing conditions along the flange of the support ring, the profiled body may be connected in substance with the flange and with the flange transition area of the support ring and in contact with the shaft of the ball pivot and/or with the connection component via sealing segments.

In a preferred embodiment of the present invention, the profiled body has a basic web connecting adjacent sealing segments. The deflection behavior of the sealing segments can be specifically influenced with this basic web during the mounting of the ball and socket joint as a function of the shape of the transition zones of the basic web in relation to the sealing segments and as a function of the thickness of the basic web.

A permanent connection between the profiled body and the flange and/or the flange transition area of the support ring can be brought about preferably by vulcanization, bonding or according to another method by a suitable adhesive connection.

According to another embodiment of the present invention, the flange of the support ring has at least one bulge reinforcing the sealing action of the profiled body.

It is also possible to arrange a sealing segment of the profiled body between adjacent bulges of the flange of the support ring, which are directed towards the connection component.

As an alternative or in addition, it is within the scope of the present invention that the bulges of the flange of the support ring directed towards the connection component carry a sealing segment of the profiled body.

If the above-mentioned two possibilities are used in combination with one another, so that bulges as well as intermediate spaces between the bulges carry sealing segments, a highly efficient and sufficiently redundant sealing system is obtained.

The profiled bodies, connected in substance to the flange or the flange transition area of the support ring, preferably consist of an elastomer or a thermoplastic elastomer (TPE). Furthermore, hard foams, e.g., PU foams, are also suitable for this, especially depending on the concrete application of the ball and socket joint.

The present invention also pertains, furthermore, to a motor vehicle, in which the ball and socket joints being claimed are used, preferably in or on components of the chassis of the motor vehicle.

The present invention will be explained in more detail below on the basis of an exemplary embodiment and corresponding drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectional view of a joint connection designed as a ball and socket joint with a connection according to the present invention of parts of a support ring and a profiled body;

FIG. 2 is a sectional view of detail X according to FIG. 1 with a profiled body in the installed and hence prestressed state;

FIG. 3 is a sectional view of detail X according to FIG. 1 with a profiled body modified compared to FIG. 2;

FIG. 4 is a sectional view of detail X according to FIG. 1 with a profiled body modified compared to FIG. 2; and

FIG. 5 is a sectional view of detail X according to FIG. 1 with a profiled body modified compared to FIG. 2.

### DESCRIPTION OF THE PREFERRED EMBODIMENTS

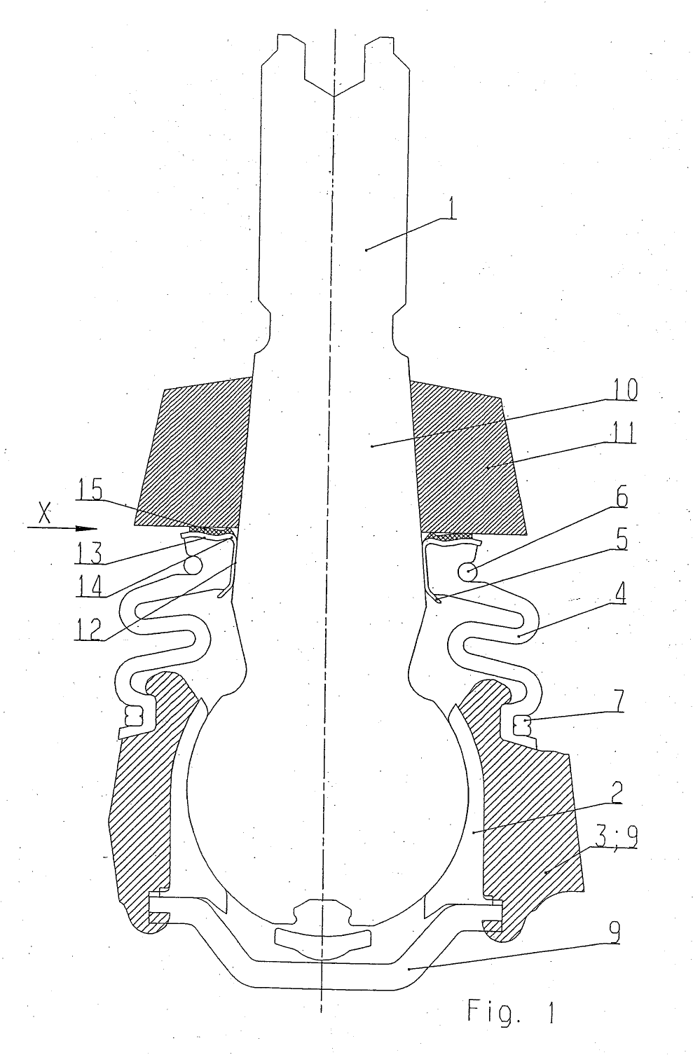

Referring to the drawings in particular, The joint connection schematically shown in FIG. 1 is a ball and socket joint, which is known per se to the person skilled in the art. The view of the design of the ball and socket joint can therefore be limited to the most important elements.

The ball and socket joint comprises essentially a ball pivot 1, a bearing shell 2 and a housing 3, which surrounds the ball pivot 1 and the bearing shell 2 at least partially. The ball and socket joint is sealed in the transition area from the housing 3 to the ball pivot 1 by a sealing bellows 4, which is held in the sealing position by means of the support ring 5, the round clamping ring 6 and the flat clamping ring 7 and makes possible a change in the relative position of the ball pivot 1 in relation to the housing 3.

The housing 3 is, in turn, of a two-part design and comprises a basic housing body 8 and a closing cover 9, which closes the housing 3 on the side facing away from the ball pivot 1 after the ball pivot 1 is inserted into the basic housing body 8.

The ball pivot 1 has a conically extending shaft 10, which is connected to a connection component 11 in a non-positive manner and carries the support ring 5, which is in turn formed from an axial extension area 12, which is in contact with the shaft 10 of the ball pivot 1, a flange 13 extending at an angle to the axial extension area 12, and a flange transition area 14 connecting an extension area 12 and the flange 13.

A profiled body 15, which consists of an elastomer, is composed of profiled sections, and which has a sealing element 16 and a basic web 17 and is sealingly in contact with the connection component 11 via the sealing segment 16, is connected by vulcanization to the flange transition area 14 and to the flange 13. As an alternative or also in addition hereto, the sealing segment 16 may be in contact with the shaft 10 of the ball pivot 1.

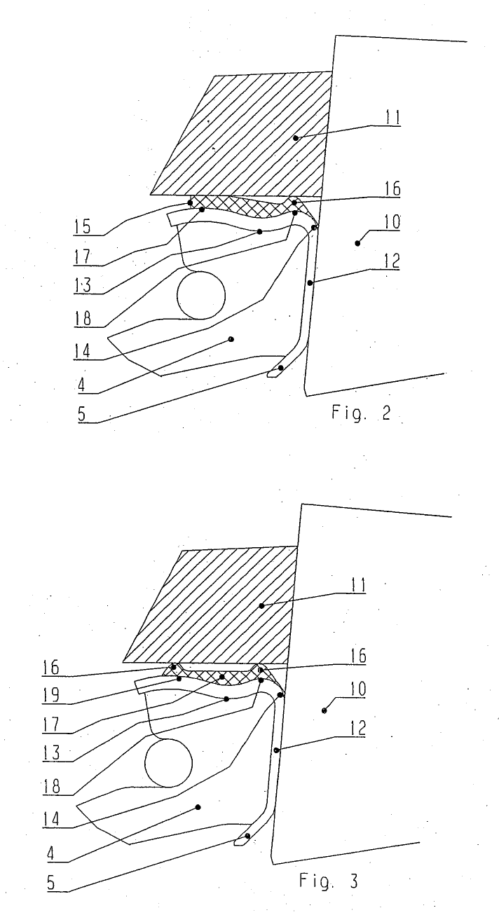

To reinforce the sealing action of the profiled body 15, a bulge 18 is provided in the flange 13 of the support ring 5, which said bulge is located close to the ball pivot and on which the sealing segment 16 is arranged, which becomes especially clear from FIG. 2.

The profiled body 15 formed from the sealing segment 16 and the basic web 17 is reliably connected in the embodiment being shown to the corresponding flange section of the support ring 5, on the basis of which reliable sealing function of the sealing element 16 is achieved close to the ball pivot.

According to the sealing situation between the flange 13 of the support ring 5 and the connection component 11, which situation is shown in FIG. 3, the profiled body 15 has two sealing segments 16, which are connected by the basic web 17. Another bulge 19, to which a sealing segment 16 is assigned, is provided in the flange 13 of the support ring 5 at a spaced location from the bulge 18 located close to the ball pivot, so that an especially reliable sealing can be brought about hereby on the basis of the redundancy provided now.

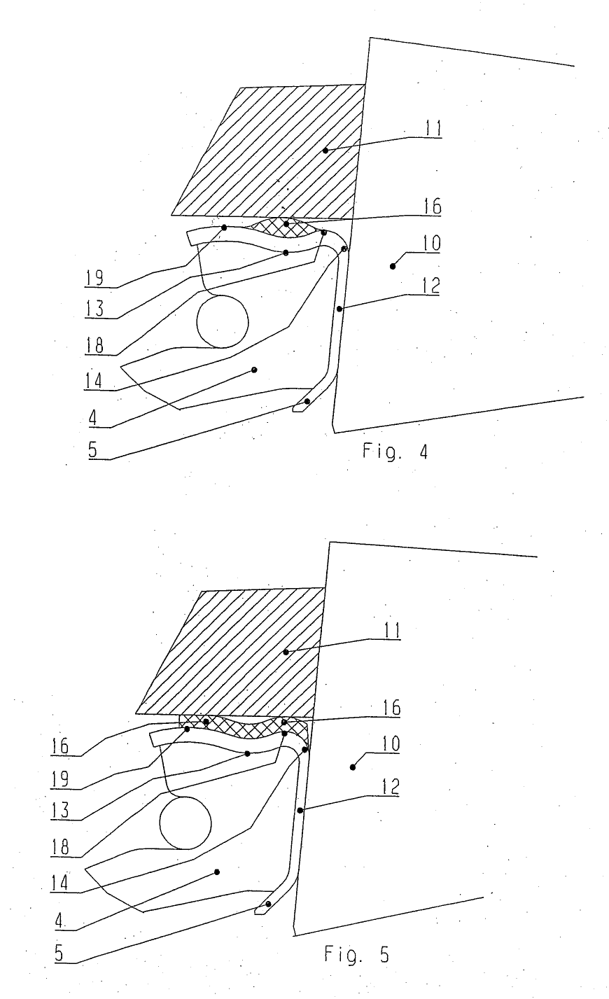

Furthermore, it is possible to embody the seal in the area of the flange 13 of the support ring 5 by a sealing segment 16, which is connected to the flange 13 of the support ring 5 in the area between the bulges 18 and 19, as is shown in FIG. 4.

According to the view in FIG. 5, the sealing segment 16 and the basic web 17 can also be adjusted such that the profiled body 15 has a layered structure and receives its profiling essentially by means of one or more bulges 18, 19 in the flange 13 or the flange transition area 14.

Regardless of the concrete design of the profiled body 15, as is shown as an example in FIGS. 2 through 5, the flange transition area 14 itself may be designed as an bulge 18 relevant for the sealing function, so that additional bulges may possibly be unnecessary in the area of the flange 13 of the support ring 5.

A highly reliable and durable sealing is achieved between the sealing bellows, the support ring, the profiled body and the connection component with the solution being shown here, which is not limited to the exemplary embodiments, and which is based essentially on the permanent connection of a support ring to one or more profiled body and the selection of suitable sealing segments as part of the particular profiled body.

While specific embodiments of the invention have been shown and described in detail to illustrate the application of the principles of the invention, it will be understood that the invention may be embodied otherwise without departing from such principles.

1. A ball and socket joint comprising:
a ball and socket joint housing having a joint opening;
a ball pivot arranged in the ball and socket joint housing, said ball pivot extending through the joint opening and having a shaft;
a support ring arranged on the shaft of the ball pivot and having a radially extending flange;
a sealing element arranged between the support ring and an adjoining connection component said sealing element being formed by a profiled body connected to said support ring with a substance connection, said profiled body sealing segment being in contact with said shaft of said ball pivot and/or with the adjoining connection component in at least one profiled section via a sealing segment arranged at said flange of said support ring and/or in said flange transition area, which establishes the connection between said flange and a axial extension area of said support ring.

2. A ball and socket joint in accordance with claim 1, wherein:
said substance connection includes a connection in substance between said flange transition area and said profiled body and
said profiled body is in contact with said shaft of said ball pivot and/or with said connection component in a profiled section via at least one said sealing segment.

3. A ball and socket joint in accordance with claim 1, wherein said profiled body is connected in substance to said flange and to said flange transition area of said support ring and is in contact with said shaft of said ball pivot and/or with said connection component via sealing elements.

4. A ball and socket joint in accordance with claim 2, wherein said profiled body has a basic web connecting said adjacent sealing segments.

5. A ball and socket joint in accordance with claim 1, wherein said profiled body is connected to said flange and/or to said flange connection area of said support ring by vulcanization, bonding or another adhesive connection.

6. A ball and socket joint in accordance with claim 1, wherein said flange of said support ring has a bulge reinforcing the sealing action of said profiled body.

7. A ball and socket joint in accordance with claim 6, wherein said flange of said support ring has another bulge and a sealing segment of said profiled body is received between adjacent bulges of said flange of said support ring, said bulges being directed towards said connection component.

8. A ball and socket joint in accordance with claim 6, wherein said bulges of said flange of said support ring, which are directed towards said connection component, carry a sealing segment of said profiled body.

9. A ball and socket joint in accordance with claim 1, wherein said profiled body consists of one or more of an elastomer, a thermoplastic elastomer (TPE), a hard foam and a PU foam.

10. (canceled)

11. A vehicle chassis component ball and socket joint comprising:
a ball and socket joint housing having a joint opening;
a ball pivot arranged in said ball and socket joint housing, said ball pivot extending through said joint opening and said ball pivot having a shaft;
a support ring arranged on the shaft of the ball pivot and having a radially extending flange and an axial extension;
a profiled body fixed on said support ring, said profiled body providing a sealing element arranged between the support ring and an adjoining chassis connection component and in contact with said shaft of said ball pivot and/or with an adjoining chassis connection component via a sealing segment arranged on at least one of said flange of said support ring and a flange transition area which establishes the connection between said flange and said axial extension of said support ring.

12. A ball and socket joint in accordance with claim 11, wherein: said profiled body is fixed on said support ring by vulcanization, bonding or another adhesive connection to form a substance connection.

13. A ball and socket joint in accordance with claim 11, wherein said profiled body has another sealing segment to provide adjacent sealing segments and said profiled body has a basic web connecting said adjacent sealing segments.

14. A ball and socket joint in accordance with claim 11, wherein said flange of said support ring has a bulge reinforcing sealing of said profiled body.

15. A ball and socket joint in accordance with claim 14, wherein said flange of said support ring has another bulge and said sealing segment of said profiled body is received between adjacent bulges of said flange, said bulges being directed towards said connection component.

16. A ball and socket joint in accordance with claim 14, wherein:
said profiled body has another sealing segment to provide adjacent sealing segments; and
said flange of said support ring has another bulge to provide bulges directed towards said chassis connection component wherein said bulges each carry a respective one of said sealing segments.

17. A ball and socket joint in accordance with claim 11, wherein said profiled body consists of one or more of an elastomer, a thermoplastic elastomer (TPE), a hard foam and a PU foam.

18. A motor vehicle comprising:
a chassis connection component; and
ball and socket joint including a ball and socket joint housing having a joint opening, a ball pivot arranged in said ball and socket joint housing, said ball pivot extending through said joint opening and said ball pivot having a shaft, a support ring arranged on the shaft of the ball pivot and having a radially extending flange and an axial extension and a profiled body fixed on said support ring, said profiled body providing a sealing element arranged between the support ring and said chassis connection component and in contact with said shaft of said ball pivot and/or with an adjoining chassis connection component via a sealing segment arranged on at least one of said flange of said support ring and a flange transition area which establishes the connection between said flange and said axial extension of said support ring, said profiled body being fixed on said support ring by vulcanization, bonding or another adhesive connection to form a substance connection.

19. A motor vehicle in accordance with claim 18, wherein said profiled body has another sealing segment to provide adjacent sealing segments and said profiled body has a basic web connecting said adjacent sealing segments.

20. A motor vehicle in accordance with claim 18, wherein:
said profiled body has another sealing segment to provide adjacent sealing segments; and
said flange of said support ring has another bulge to provide bulges directed towards said chassis connection component wherein said bulges each carry a respective one of said sealing segments.

21. A motor vehicle in accordance with claim 18, wherein said profiled body consists of one or more of an elastomer, a thermoplastic elastomer (TPE), a hard foam and a PU foam.
